(19) United States
(12) Patent Application Publication
(10) Pub. No.: US 2026/0304270 A1
(43) Pub. Date: Oct. 1, 2026

(54) METHODS FOR HANDOVER ENHANCEMENT FOR NON-TERRESTRIAL NETWORK IN WIRELESS COMMUNICATIONS

(71) Applicant: MEDIATEK SINGAPORE PTE. LTD., Singapore (SG)

(72) Inventors: Abdelkader MEDLES, Cambridge (GB); Gilles CHARBIT, Cambridge (GB); Chun-Chia CHEN, Hsinchu City (TW); I-Kang FU, Hsinchu City (TW)

(73) Assignee: MEDIATEK SINGAPORE PTE. LTD., Singapore (SG)

(21) Appl. No.: 19/475,723

(22) PCT Filed: Sep. 5, 2024
(86) PCT No.: PCT/CN2024/117236

§ 371 Date: Oct. 15, 2025

Related U.S. Application Data
(60) Provisional application No. 63/587,760, filed on Oct. 4, 2023.

(51) Int. Cl. H04W 36/18; H04W 36/00; H04W 36/08; H04W 84/06

(52) U.S. Cl. CPC H04W 36/18; H04W 36/0072; H04W 36/083; H04W 84/06

(57) ABSTRACT

Various solutions for handover enhancement for non-terrestrial network (NTN) in wireless communications are described. An apparatus may report very small aperture terminal (VSAT) user equipment (UE) capability information to a first network node with a first satellite. Then, the apparatus may receive a handover command from the first network node. The handover command may indicate a handover from the first network node to a second network node with a second satellite. The apparatus may further re-steer a VSAT antenna towards the second satellite within a VSAT antenna re-steering duration, and perform the handover after the VSAT antenna re-steering duration.

### CROSS REFERENCE TO RELATED PATENT APPLICATION(S)

The present disclosure is part of a non-provisional application claiming the priority benefit of U.S. Provisional Patent Application No. 63/587,760, filed 4 Oct. 2023, the content of which herein being incorporated by reference in its entirety.

### TECHNICAL FIELD

The present disclosure is generally related to wireless communications and, more particularly, to handover enhancement for non-terrestrial network (NTN) with respect to very small aperture terminal (VSAT) user equipment (UE) and network node in wireless communications.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, NTN is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

For satellite communications, a large antenna or a large phase array at the UE side may be required to close the link budget and this type of UE may be referred to as a VSAT UE. In an NTN, due to the satellite is moving, a VSAT UE may need to perform handover (e.g., from a source satellite to a target satellite), so as to ensure normal transmission/reception during a long connection time and to avoid radio link failure. For example, re-steering the VSAT antenna towards the target satellite may induce a significant delay in seconds or even tens of seconds. However, in current 3GPP Release 18 standards, the handover mechanism is designed without taking the re-steering delay into account. Consequently, the physical random access channel (PRACH) resources for the UE's initial access at the target satellite will be reserved for longer time. Moreover, since the handover-related timers are not adapted for satellite scenarios, the UE operations during the handover may not work correctly (e.g., the UE may not have enough time to complete the handover).

Accordingly, how to optimize the handover mechanism for satellite scenarios becomes an important topic for modern wireless communication systems. Therefore, there is a need to provide proper schemes to address the above-described issues.

Therefore, there is a need to provide proper schemes and designs for procedures allowing the UE and the network to perform satellite switching in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to handover enhancement for NTN in wireless communications. It is believed that the above-described issues would be avoided or otherwise alleviated by implementing one or more of the proposed schemes described herein.

In one aspect, a method may involve an apparatus reporting VSAT UE capability information to a first network node, wherein the first network node comprises or is associated with a first satellite. The method may also involve the apparatus receiving a handover command from the first network node, wherein the handover command indicates a handover from the first network node to a second network node which comprises or is associated with a second satellite. The method may further involve the apparatus re-steering a VSAT antenna towards the second satellite within a VSAT antenna re-steering duration. The method may further involve the apparatus performing the handover after the VSAT antenna re-steering duration.

In one aspect, a method may involve a first network node receiving VSAT UE capability information from an apparatus, wherein the first network node comprises or is associated with a first satellite. The method may also involve the first network node transmitting a handover command to the apparatus according to the VSAT UE capability information, wherein the handover command indicates a handover from the first network node to a second network node which comprises or is associated with a second satellite.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a VSAT UE undergoing a handover from one satellite to another in accordance with the present disclosure.

FIG. 2 is a diagram depicting an example scenario of a communication environment in which various solutions and schemes in accordance with the present disclosure may be implemented.

FIG. 3 is a diagram depicting an example scenario of an enhanced handover procedure for NTN in accordance with an implementation of the present disclosure.

FIG. 4 is a diagram depicting an example scenario of an enhanced handover procedure for NTN in accordance with another implementation of the present disclosure.

FIG. 5 is a diagram depicting an example scenario of an enhanced handover procedure for NTN in accordance with another implementation of the present disclosure.

FIG. 6 is a diagram depicting an example scenario of an enhanced handover procedure for NTN in accordance with another implementation of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handover enhancement for NTN in wireless communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on. It is noteworthy that the present disclosure is motivated by, but not limited to, an NTN scenario.

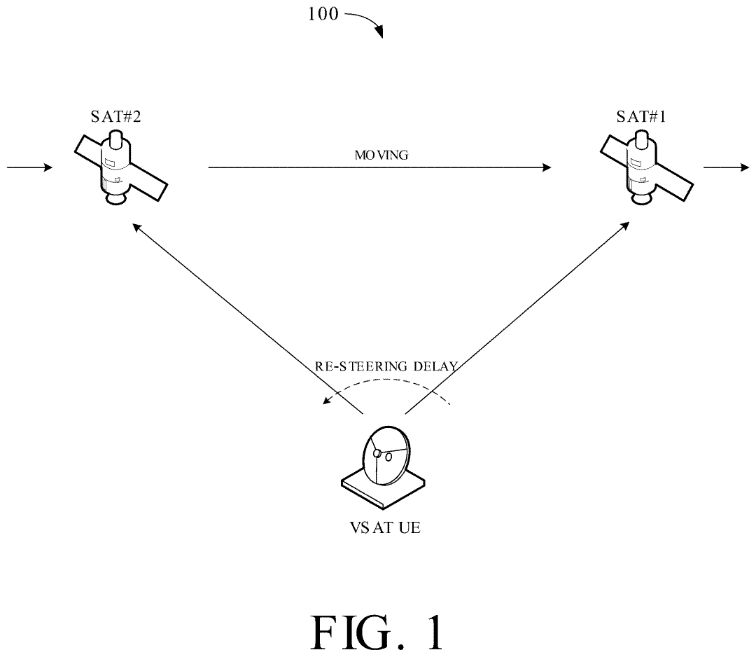

In an NTN, due to the satellite is moving, a VSAT UE may need to perform handover (e.g., from a source satellite to a target satellite), so as to ensure normal transmission/reception during a long connection time and to avoid radio link failure. To prepare for the handover, the VSAT UE needs to re-steer the VSAT antenna towards the target satellite and this may induce a significant delay in seconds or even tens of seconds. For example, in the case of the VSAT UE using a mechanical steering antenna, the rotor required to move the antenna may have a speed of 2-10 degrees per second. FIG. 1 illustrates an example scenario 100 of a VSAT UE undergoing a handover from one satellite to another in accordance with the present disclosure. Scenario 100 involves a VSAT UE in wireless communication with satellite 1 (denoted as SAT #1) initially. Then, with the satellites moving as time advances, the area where the VSAT UE is located will be no longer served by satellite 1 and be served by satellite 2 (denoted as SAT #2) instead. To ensure normal transmission/reception and to avoid radio link failure, the VSAT UE will need to perform a handover to switch the communication link from satellite 1 to satellite 2. Accordingly, before performing the handover, the VSAT UE needs to re-steer its VSAT antenna towards satellite 2 with a re-steering delay.

It should be noted that, in 3GPP Release 18, the current handover mechanism is designed without taking the re-steering delay into account. Consequently, the PRACH resources for the UE's initial access at the target satellite will be reserved for longer time. Moreover, since the handover-related timers are not adapted for satellite scenarios, the UE operations during the handover may not work correctly (e.g., the UE may not have enough time to complete the handover).

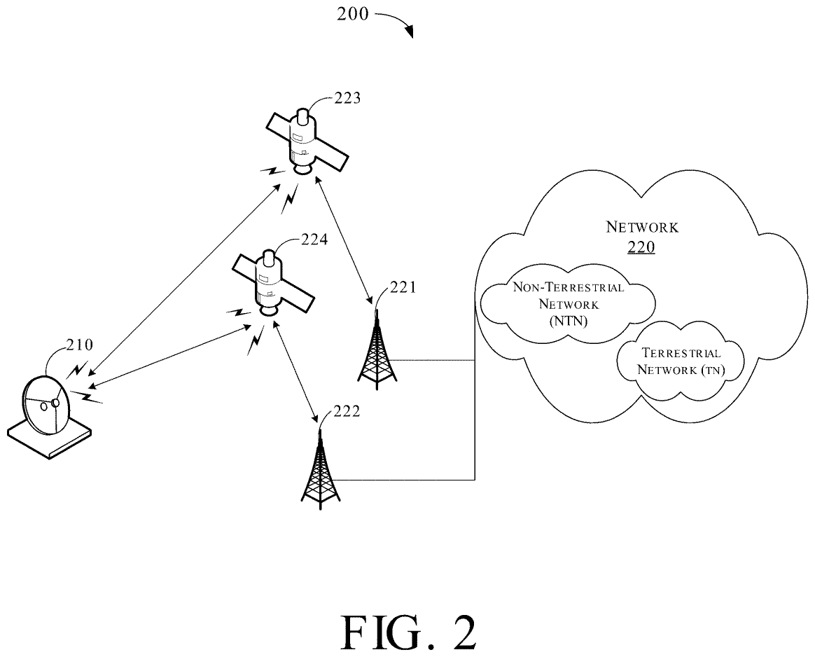

In view of the above, the present disclosure proposes a number of schemes pertaining to handover enhancement for NTN in wireless communications. FIG. 2 illustrates an example scenario 200 of a communication environment in which various solutions and schemes in accordance with the present disclosure may be implemented. Scenario 200 involves a UE 210 (e.g., a VSAT UE) in wireless communication with a network 220 (e.g., a wireless network including an NTN and a TN) via one or more terrestrial network nodes 221-222 (e.g., a base station (BS) such as an evolved Node-B (eNB), a gNB, or a transmission/reception point (TRP)) and one or more non-terrestrial network nodes 223-224 (e.g., satellite(s)). In some implementations, the terrestrial network node 221 and the non-terrestrial network node 223 may form an NTN serving cell for wireless communication with the UE 210. Likewise, the terrestrial network node 222 and the non-terrestrial network node 224 may form an NTN serving cell for wireless communication with the UE 210. Alternatively, the non-terrestrial network node 223/224 may have built-in BS functionalities to form an NTN serving cell for wireless communication with the UE 210, without involving any BS. In such communication environment as shown in FIG. 2, the UE 210, the terrestrial network nodes 221-222, and the non-terrestrial network node 223-224 may implement various schemes pertaining to handover enhancement for NTN in wireless communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under a first proposed scheme of the present disclosure, a VSAT UE may report VSAT UE capability information to the source network node. Specifically, the VSAT UE capability information includes information that allows the source network node to know how long it would take to steer the VSAT antenna from the source satellite to the target satellite, such that the source network node may initiate the handover procedure according to the VSAT UE capability information. Accordingly, the VSAT UE may re-steer the VSAT antenna towards the target satellite within a VSAT antenna re-steering duration, and then perform the handover after the VSAT antenna re-steering duration.

In some implementations, the VSAT UE capability information may include at least a VSAT antenna type indicating whether the VSAT UE uses electronic or mechanical steering antenna. Additionally, or optionally, the VSAT UE capability information may include a capability of receiving from more than one satellite at a same time (while using multiple UE beams or multiple VSAT antenna or phase array antennas), and/or a capability of maintaining a link with the source network node or satellite during the VSAT antenna re-steering duration (e.g., for electronic steering antenna). For example, the VSAT UE may report the VSAT UE capability information during a UE capability transfer procedure. The capability transfer procedure may be initiated by a UECapabilityEnquiry message from the source network node. Upon receiving the UECapabilityEnquiry message, the VSAT UE may reply to the source network node with a UECapabilityInformation message including the VSAT UE capability information.

In some implementations, the VSAT UE capability information may include a parameter related to the VSAT antenna re-steering duration. In option 1, the parameter may indicate a rotor speed, e.g., in degrees per second, and the source network node may use the approximate UE position and the source and target satellite positions to calculate the VSAT antenna re-steering duration. In option 2, the parameter may indicate a value of the VSAT antenna re-steering duration, e.g., the UE may calculate the VSAT antenna re-steering duration using the source and target satellite positions and report the calculated duration plus some additional margin (depending on other overheads) to the source network node. For electronic steering antenna (e.g., phase array), option 2 may be applicable as the steering may take time in terms of preparation and to take effect. Additionally, or optionally, the parameter may indicate at least one of the following: (i) a VSAT antenna re-steering time level, e.g., long, medium, or short; (ii) a minimum VSAT antenna re-steering time (e.g., for a predefined re-steering angle); and (iii) a maximum VSAT antenna re-steering time (e.g., for a predefined re-steering angle).

In some implementations, the VSAT UE may report the parameter related to the VSAT antenna re-steering duration according to network's request. For example, the source network node may transmit a request message (e.g., a handover command) including assistance information to the VSAT UE. The assistance information may include ephemeris information, an epoch time, and a start service time of the target satellite, such that the VSAT UE may estimate/determine a value of the VSAT antenna re-steering duration based on the assistant information. Then, the VSAT UE may respond to the request message by reporting the estimated value to the source network node.

Under a second proposed scheme of the present disclosure, a new timer (e.g., called Resteering_timer or offset timer) may be introduced to handle the VSAT antenna re-steering time. The new timer may be triggered at the start of the handover procedure at the UE side (e.g., the new timer is started upon receiving a handover command), and the UE will not perform initial access (e.g., PRACH transmission) to the target satellite until the new timer expires. The start of the handover timer (e.g., T304) at the UE side may be delayed until the new timer expires. The value of the new timer may be determined by the source network node and signaled to the UE, or determined by the UE and signaled to the source network node. Alternatively, the value of the new timer may be determined based on a predetermined table (e.g., defined in 3GPP standards) at both the BS side and UE side (e.g., both BS and UE may pick the same value according to the predetermined table).

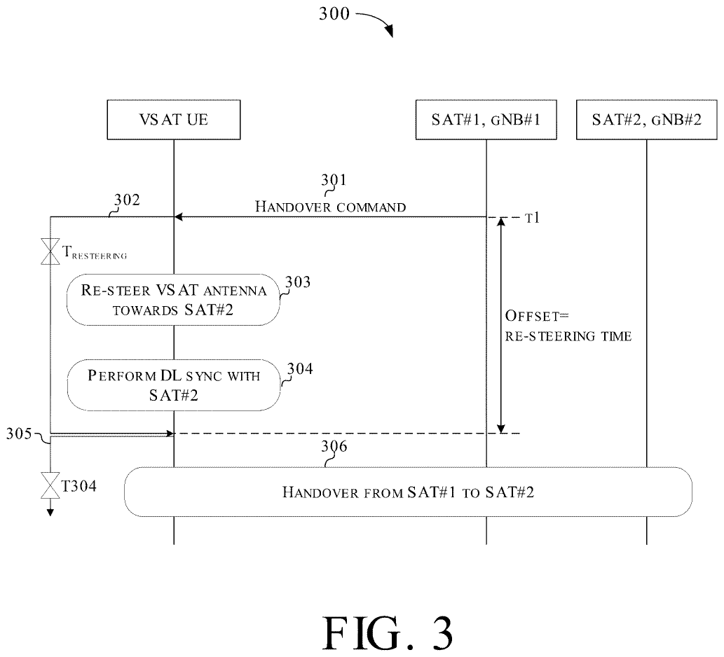

FIG. 3 illustrates an example scenario 300 of an enhanced handover procedure for NTN in accordance with an implementation of the present disclosure. At 301, the VSAT UE may receive a handover command (e.g., an RRCReconfiguration message) from the source network node (denoted as SAT #1 and/or gNB #1). At 302, the VSAT UE may start the re-steering timer (denoted as Tre-steering) with an offset value upon receiving the handover command. In one example, the offset value may be included in the handover command. In another example, if the handover command does not include an offset value, the VSAT UE may set the offset value to the reported value of the VSAT antenna re-steering duration. At 303, the VSAT UE may re-steer the VSAT antenna towards the target satellite (denoted as SAT #2). At 304, the VSAT UE may perform downlink (DL) synchronization with the target satellite once the VSAT antenna is re-steered to point to the target satellite. At 305, after the re-steering time expires, the VSAT UE may start the handover timer (denoted as T304). At 306, the VSAT UE may perform the handover procedure (e.g., including a random access procedure). Meanwhile, at the source satellite, the PRACH resources (e.g., random access preambles) for the UE's handover may be reserved according to the offset value. For example, the PRACH resources for the UE's handover may be reserved from the time {t1+offset} to the time {t1+offset+T304}.

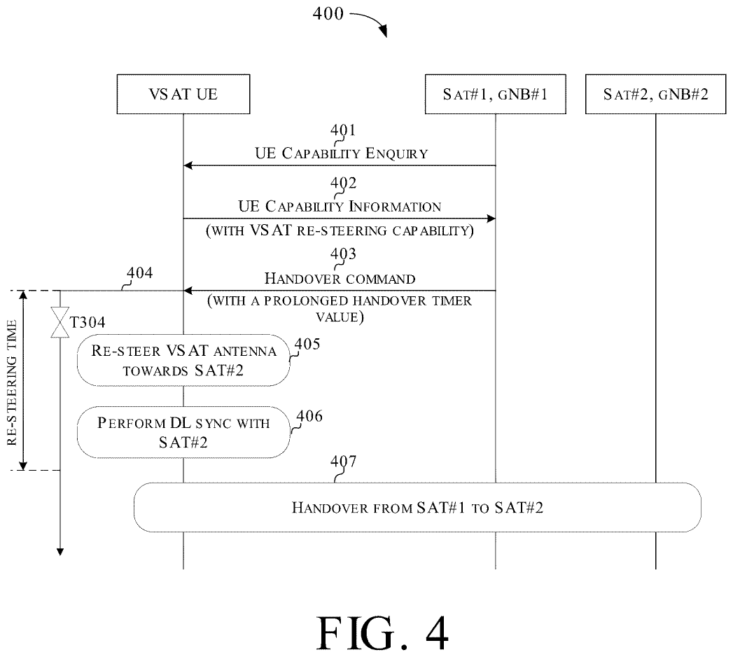

FIG. 4 illustrates an example scenario 400 of an enhanced handover procedure for NTN in accordance with another implementation of the present disclosure. At 401, the VSAT UE may receive a UECapabilityEnquiry message from the source network node (denoted as SAT #1 and/or gNB #1). At 402, the VSAT UE may transmit a UECapabilityInformation message including the VSAT UE capability information to the source network node. At 403, the VSAT UE may receive a handover command (e.g., an RRCReconfiguration message) including a prolonged handover timer value from the source network node (denoted as SAT #1 and/or gNB #1). At 404, the VSAT UE may start the handover timer (denoted as T304) with the prolonged handover timer value upon receiving the handover command. At 405, the VSAT UE may re-steer the VSAT antenna towards the target satellite (denoted as SAT #2). At 406, the VSAT UE may perform DL synchronization with the target satellite once the VSAT antenna is re-steered to point to the target satellite. At 407, the VSAT UE may perform the handover procedure (e.g., including a random access procedure). It is noteworthy that the handover timer value is prolonged to cover the UE's re-steering time, such that the VSAT UE may have enough time to complete the handover procedure after the antenna re-steering operations.

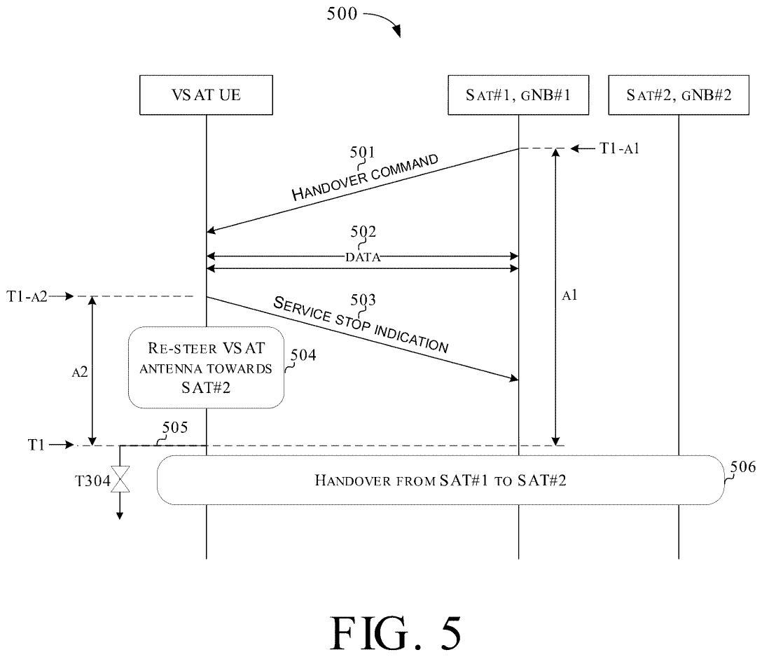

FIG. 5 illustrates an example scenario 500 of an enhanced handover procedure for NTN in accordance with another implementation of the present disclosure. At 501, the VSAT UE may receive a handover command (e.g., an RRCReconfiguration message) from the source network node (denoted as SAT #1 and/or gNB #1). Specifically, the handover command includes the ephemeris information, the epoch time and the start service time (denoted as T1) of the target satellite. The source network node may transmit the handover command before the start service time with an offset (denoted as a1) which may be larger than the maximum re-steering time of the VSAT UE. For example, the source network node may transmit the handover command at the time {T1-a1} . At 502, after receiving the handover command, the VSAT UE may continue data transmissions/receptions with the source satellite (depending on the UE's capability) for a while. At 503, the VSAT UE may transmit a service stop indication to inform network to stop service at the source satellite. The service stop indication (e.g., via a radio resource control (RRC) message or a medium access control (MAC) control element (CE)) may be transmitted based on the required re-steering time (denoted as a2). For example, the VSAT UE may transmit the service stop indication at the time {T1-a2}. At 504, the VSAT UE may re-steer the VSAT antenna towards the target satellite (denoted as SAT #2). At 505, the VSAT UE may start the handover timer (denoted as T304) at T1. At 506, the VSAT UE may perform the handover procedure (e.g., including a random access procedure).

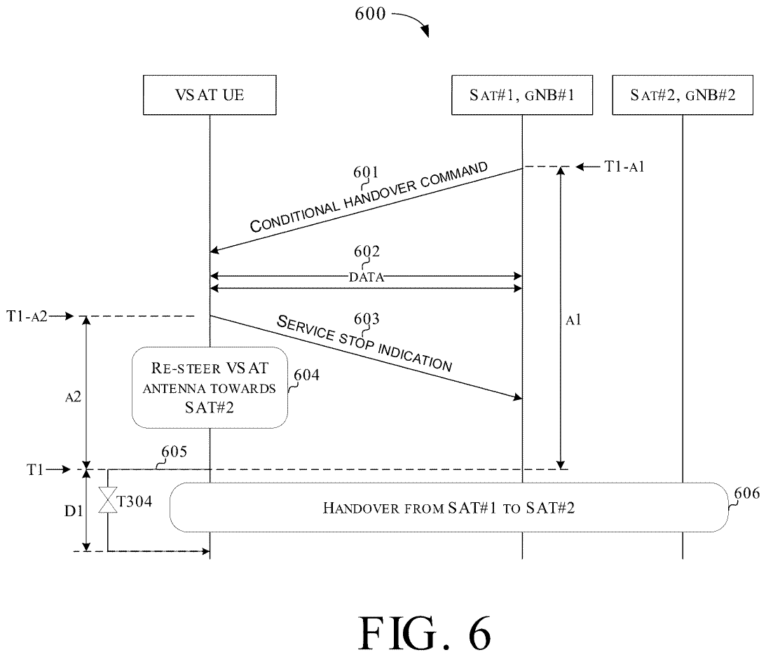

FIG. 6 illustrates an example scenario 600 of an enhanced handover procedure for NTN in accordance with another implementation of the present disclosure. Scenario 600 is similar to scenario 500, except that at 601, the handover command is a conditional handover command which includes not only the start service time of the target satellite (denoted as T1) but also a duration (denoted as D1) of the service time. For example, the condition for triggering the handover procedure may be when the time comes to T1. That is, at the time T1, the VSAT UE may start the handover timer with D1 and then perform the handover procedure.

### Illustrative Implementations

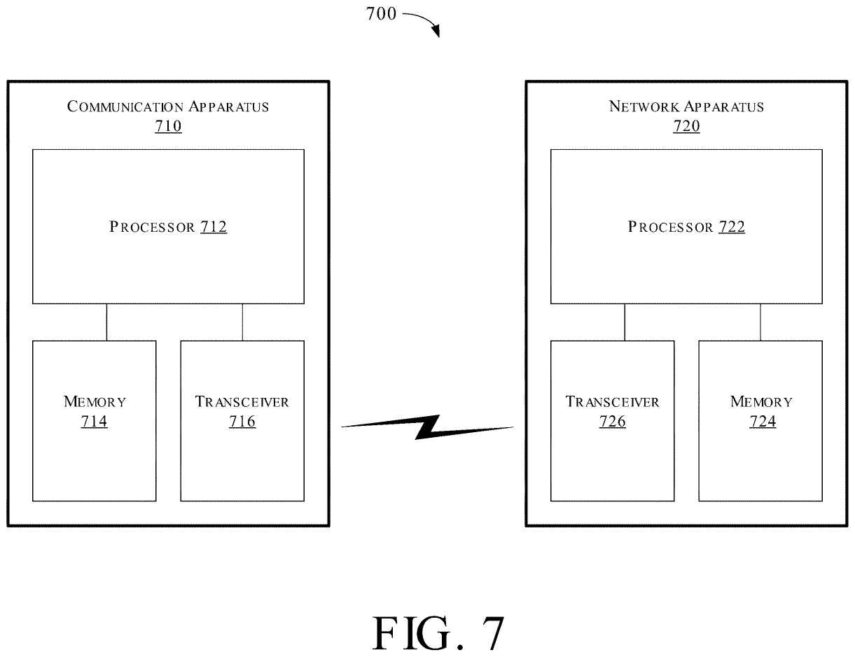

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to handover enhancement for NTN in wireless communications, including scenarios/schemes described above as well as processes 800 and 900 described below.

Communication apparatus 710 may be a part of an electronic apparatus, which may be a VSAT UE such as a wireless communication apparatus or a computing apparatus, which may be mounted on a ship or vehicle, or installed on the roof a building (e.g., home or office), to provide internet access through satellite communications. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of an electronic apparatus, which may be a network node such as a satellite, a BS, a small cell, a router or a gateway of an NTN. For instance, network apparatus 720 may be implemented in a satellite and/or an eNB/gNB/TRP in a 4G/5G, NR, IoT, NB-IoT or IIoT network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks, including handover enhancement for NTN, in a device (e.g., as represented by communication apparatus 710) and a network node (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, transceiver 716 may be capable of wirelessly communicating with different types of UEs and/or wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, transceiver 716 may be equipped with a rotor if mechanical steering antenna is used. Alternatively, transceiver 716 may be equipped with phase antenna(s) if electronic steering antenna is used. In some implementations, network apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, communication apparatus 710 may further include a memory 714 coupled to processor 712 and capable of being accessed by processor 712 and storing data therein. In some implementations, network apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 710 and network apparatus 720 may be a communication entity capable of communicating with each other using various proposed schemes in accordance with the present disclosure. For illustrative purposes and without limitation, a description of capabilities of communication apparatus 710, as a UE, and network apparatus 720, as a network node (e.g., satellite), is provided below with processes 800 and 900.

### Illustrative Processes

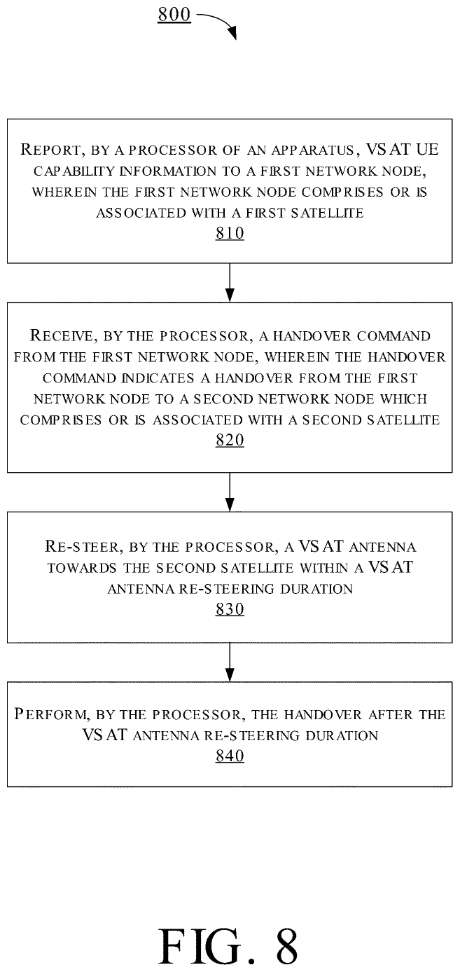

FIG. 8 illustrates an example process 800 in accordance with an implementation of the present disclosure. Process 800 may be an example implementation of above scenarios/schemes, whether partially or completely, with respect to handover enhancement for NTN in wireless communications. Process 800 may represent an aspect of implementation of features of communication apparatus 710. Process 800 may include one or more operations, actions, or functions as illustrated by one or more of blocks 810 to 840. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by or in communication apparatus 710 or any suitable UE. Solely for illustrative purposes and without limitation, process 800 is described below in the context of communication apparatus 710. Process 800 may begin at block 810.

At 810, process 800 may involve processor 712 of communication apparatus 710 reporting, via transceiver 716, VSAT UE capability information to a first network node (e.g., network apparatus 720), wherein the first network node comprises or is associated with a first satellite. Process 800 may proceed from 810 to 820.

At 820, process 800 may involve processor 712 receiving, via transceiver 716, a handover command from the first network node, wherein the handover command indicates a handover from the first network node to a second network node which comprises or is associated with a second satellite. Process 800 may proceed from 820 to 830.

At 830, process 800 may involve processor 712 re-steering a VSAT antenna towards the second satellite within a VSAT antenna re-steering duration. Process 800 may proceed from 830 to 840.

At 840, process 800 may involve processor 712 performing, via transceiver 716, the handover after the VSAT antenna re-steering duration.

In some implementations, the VSAT UE capability information may include at least one of the following: (i) a VSAT antenna type indicating whether a VSAT UE uses electronic or mechanical steering antenna; (ii) a capability of receiving from more than one satellite at a same time; and (iii) a capability of maintaining a link with the first satellite during the VSAT antenna re-steering duration.

In some implementations, the VSAT UE capability information may include a parameter related to the VSAT antenna re-steering duration, and the parameter may indicate at least one of the following: (i) a rotor speed; (ii) a value of the VSAT antenna re-steering duration; (iii) a VSAT antenna re-steering time level; (iv) a minimum VSAT antenna re-steering time; and (v) a maximum VSAT antenna re-steering time.

In some implementations, process 800 may further involve processor 712 starting a re-steering timer with a value of the VSAT antenna re-steering duration upon receiving the handover command, and starting a handover timer at a start of performing the handover in an event that the re-steering timer expires.

In some implementations, the handover command may include the value of the VSAT antenna re-steering duration.

In some implementations, process 800 may further involve processor 712 receiving, via transceiver 716, assistance information from the first network node, wherein the assistance information comprises ephemeris information, an epoch time, and a start service time of the second satellite. Additionally, process 800 may further involve processor 712 determining a value of the VSAT antenna re-steering duration based on the assistance information.

In some implementations, the assistance information may be received in a request message, and the value of the VSAT antenna re-steering duration may be reported to the first network node responsive to the request message.

In some implementations, process 800 may further involve processor 712 starting a handover timer upon receiving the handover command, wherein the handover timer is configured with a value larger than that of the VSAT antenna re-steering duration.

In some implementations, the handover command may include ephemeris information, an epoch time, and a start service time of the second satellite. Additionally, process 800 may further involve processor 712 transmitting, via transceiver 716, a service stop indication to the first satellite before performing the handover, based on the VSAT antenna re-steering duration and the start service time.

In some implementations, the service stop indication may be transmitted in an RRC message or a MAC CE.

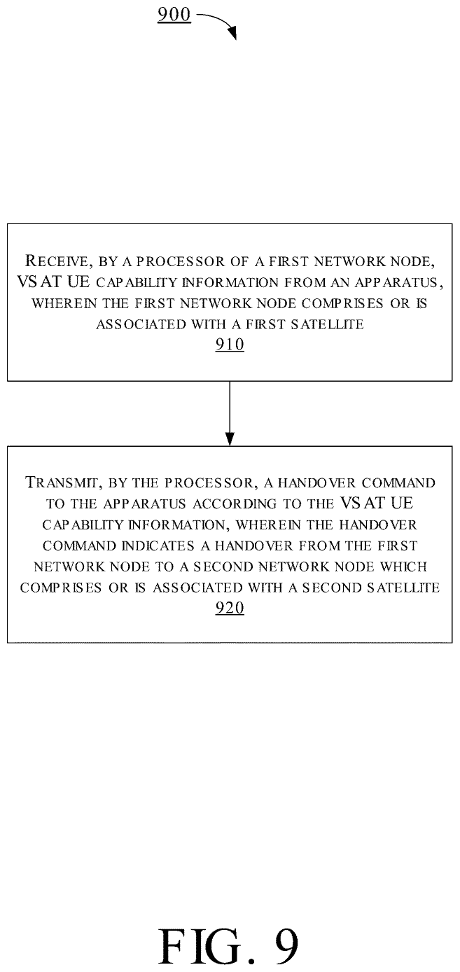

FIG. 9 illustrates an example process 900 in accordance with an implementation of the present disclosure. Process 900 may be an example implementation of above scenarios/schemes, whether partially or completely, with respect to handover enhancement for NTN in wireless communications. Process 900 may represent an aspect of implementation of features of network apparatus 720. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by or in network apparatus 720 as well as any variations thereof. Solely for illustrative purposes and without limitation, process 900 is described below in the context of network apparatus 720. Process 900 may begin at block 910.

At block 910, process 900 may involve processor 722 of network apparatus 720 receiving, via transceiver 726, VSAT UE capability information from an apparatus (e.g., communication apparatus 710), wherein network apparatus 720 comprises or is associated with a first satellite. Process 900 may proceed from block 910 to block 920.

At block 920, process 900 may involve processor 722 transmitting, via transceiver 726, a handover command to the apparatus according to the VSAT UE capability information, wherein the handover command indicates a handover from network apparatus 720 to another network node which comprises or is associated with a second satellite.

In some implementations, the VSAT UE capability information may include at least one of the following: (i) a VSAT antenna type indicating whether a VSAT UE uses electronic or mechanical steering antenna; (ii) a capability of receiving from more than one satellite at a same time; and (iii) a capability of maintaining a link with the first satellite during the VSAT antenna re-steering duration.

In some implementations, the VSAT UE capability information may include a parameter related to the VSAT antenna re-steering duration, and the parameter may indicate at least one of the following: (i) a rotor speed; (ii) a value of the VSAT antenna re-steering duration; (iii) a VSAT antenna re-steering time level; (iv) a minimum VSAT antenna re-steering time; and (v) a maximum VSAT antenna re-steering time.

In some implementations, the VSAT antenna re-steering duration allows the apparatus to re-steer a VSAT antenna towards the second satellite before performing the handover.

In some implementations, the handover command may include a value of the VSAT antenna re-steering duration.

In some implementations, process 900 may further involve processor 722 transmitting, via transceiver 726, assistance information to the apparatus, wherein the assistance information comprises ephemeris information, an epoch time, and a start service time of the second satellite, such that the apparatus determines a value of the VSAT antenna re-steering duration based on the assistance information.

In some implementations, the assistance information may be transmitted in a request message, and the value of the VSAT antenna re-steering duration may be received from the apparatus responsive to the request message.

In some implementations, the handover command may include a handover timer configured with a value larger than that of the VSAT antenna re-steering duration.

In some implementations, the handover command may include ephemeris information, an epoch time, and a start service time of the second satellite. Additionally, process 900 may further involve processor 722 receiving, via transceiver 726, a service stop indication for the first satellite, wherein the service stop indication is transmitted by the apparatus based on the VSAT antenna re-steering duration and the start service time.

In some implementations, the service stop indication may be received in an RRC message or a MAC CE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
reporting, by a processor of an apparatus, very small aperture terminal (VSAT) user equipment (UE) capability information to a first network node, wherein the first network node comprises or is associated with a first satellite;
receiving, by the processor, a handover command from the first network node, wherein the handover command indicates a handover from the first network node to a second network node which comprises or is associated with a second satellite;
re-steering, by the processor, a VSAT antenna towards the second satellite within a VSAT antenna re-steering duration; and
performing, by the processor, the handover after the VSAT antenna re-steering duration.

2. The method of claim 1, wherein the VSAT UE capability information comprises at least one of the following:
a VSAT antenna type indicating whether a VSAT UE uses electronic or mechanical steering antenna;
a capability of receiving from more than one satellite at a same time; and
a capability of maintaining a link with the first satellite during the VSAT antenna re-steering duration.

3. The method of claim 1, wherein the VSAT UE capability information comprises a parameter related to the VSAT antenna re-steering duration, and the parameter indicates at least one of the following:
a rotor speed;
a value of the VSAT antenna re-steering duration;
a VSAT antenna re-steering time level;
a minimum VSAT antenna re-steering time; and
a maximum VSAT antenna re-steering time.

4. The method of claim 1, further comprising:
starting, by the processor, a re-steering timer with a value of the VSAT antenna re-steering duration upon receiving the handover command; and
starting, by the processor, a handover timer at a start of performing the handover in an event that the re-steering timer expires.

5. The method of claim 4, wherein the handover command comprises the value of the VSAT antenna re-steering duration.

6. The method of claim 1, further comprising:
receiving, by the processor, assistance information from the first network node, wherein the assistance information comprises ephemeris information, an epoch time, and a start service time of the second satellite; and
determining, by the processor, a value of the VSAT antenna re-steering duration based on the assistance information.

7. The method of claim 6, wherein the assistance information is received in a request message, and the value of the VSAT antenna re-steering duration is reported to the first network node responsive to the request message.

8. The method of claim 1, further comprising:
starting, by the processor, a handover timer upon receiving the handover command, wherein the handover timer is configured with a value larger than that of the VSAT antenna re-steering duration.

9. The method of claim 1, wherein the handover command comprises ephemeris information, an epoch time, and a start service time of the second satellite, and the method further comprises:
transmitting, by the processor, a service stop indication to the first satellite before performing the handover, based on the VSAT antenna re-steering duration and the start service time.

10. The method of claim 9, wherein the service stop indication is transmitted in a radio resource control (RRC) message or a medium access control (MAC) control element (CE).

11. A method, comprising:
receiving, by a processor of a first network node, very small aperture terminal (VSAT) user equipment (UE) capability information from an apparatus, wherein the first network node comprises or is associated with a first satellite; and
transmitting, by the processor, a handover command to the apparatus according to the VSAT UE capability information, wherein the handover command indicates a handover from the first network node to a second network node which comprises or is associated with a second satellite.

12. The method of claim 11, wherein the VSAT UE capability information comprises at least one of the following:
a VSAT antenna type indicating whether a VSAT UE uses electronic or mechanical steering antenna;
a capability of receiving from more than one satellite at a same time; and
a capability of maintaining a link with the first satellite during the VSAT antenna re-steering duration.

13. The method of claim 11, wherein the VSAT UE capability information comprises a parameter related to the VSAT antenna re-steering duration, and the parameter indicates at least one of the following:
a rotor speed;
a value of the VSAT antenna re-steering duration a VSAT antenna re-steering time level;
a minimum VSAT antenna re-steering time; and
a maximum VSAT antenna re-steering time.

14. The method of claim 11, wherein the VSAT antenna re-steering duration allows the apparatus to re-steer a VSAT antenna towards the second satellite before performing the handover.

15. The method of claim 11, wherein the handover command comprises a value of the VSAT antenna re-steering duration.

16. The method of claim 11, further comprising:
transmitting, by the processor, assistance information to the apparatus, wherein the assistance information comprises ephemeris information, an epoch time, and a start service time of the second satellite, such that the apparatus determines a value of the VSAT antenna re-steering duration based on the assistance information.

17. The method of claim 16, wherein the assistance information is transmitted in a request message, and the value of the VSAT antenna re-steering duration is received from the apparatus responsive to the request message.

18. The method of claim 11, wherein the handover command comprises a handover timer configured with a value larger than that of the VSAT antenna re-steering duration.

19. The method of claim 11, wherein the handover command comprises ephemeris information, an epoch time, and a start service time of the second satellite, and the method further comprises:
receiving, by the processor, a service stop indication for the first satellite, wherein the service stop indication is transmitted by the apparatus based on the VSAT antenna re-steering duration and the start service time.

20. The method of claim 19, wherein the service stop indication is received in a radio resource control (RRC) message or a medium access control (MAC) control element (CE).
